(19) United States
(12) Patent Application Publication
(10) Pub. No.: US 2011/0256507 A1
(43) Pub. Date: Oct. 20, 2011

(54) Computerized Method For Coloring Porcelain Tooth

(76) Inventors: Yi-Da Chiu, Taichung (TW); Chun-Ching Lee, Hsinchu (TW); Wen-Ching Wu, Taipei (TW); Ming-Tzung Lee, Taipei (TW)

(21) Appl. No.: 12/763,219

(22) Filed: Apr. 20, 2010

(51) Int. Cl. A61C 13/083; B05D 7/00

(52) U.S. Cl. 433/203.1; 427/2.29; 433/215

(57) ABSTRACT

A computerized method for coloring a porcelain tooth includes a color difference comparison step, a first computer aided process, and a second computer aided process, for precisely controlling the color of the porcelain tooth. Each parameter is obtained from data comparison. The first computer aided process forms a first layer on the surface of the porcelain tooth and then and the second computer aided process forms a second layer on the first layer by way of computer aided manufacturing (CAM) according to the color difference comparison step. Because of CAM, the method does not require an experienced operator. Therefore, it may reduce labor cost, human error, and ceramic powder consumption. The method may thus save cost, improve production efficiency, and shorten delivery time of the porcelain tooth product.

### BACKGROUND OF THE INVENTION

1. Field of the Invention

The present invention relates to a computerized method for coloring a porcelain tooth, and more particularly, to a computerized method for coloring porcelain tooth including a color difference comparison step, a first computer aided process, and a second computer aided process.

2. The Prior Art

Referring to FIG. 1, a conventional porcelain tooth structure 1 includes a porcelain tooth 11, a bottom color layer 13, a dentine layer 15, and an enamel layer 17.

FIG. 2 is a flow chart showing a conventional method for coloring a porcelain tooth. As shown in FIG. 2, the conventional method for coloring the porcelain tooth includes the following steps: manually mixing dyes S11, manually spreading base color coating S13, heat drying the base color coating S15, high-temperature sintering the base color coating S17, manually spreading dentine coating S19, heat drying the dentine coating S21, high-temperature sintering the dentine coating S23, manually spreading enamel coating S25, heat drying the enamel coating S27, and high-temperature sintering the enamel coating S29.

In the conventional method, due to the manual spreading manner, every coating needs to be mixed, spread, and adjusted by man power. After the coating is sintered, the color appearance of the porcelain tooth depends on the selected dyes. Therefore, it needs experienced operators to color the porcelain tooth, which demands a relatively high labor cost. Moreover, manual coloring taking a longer time to finish the job and thus it takes a longer time to deliver. Human errors may be more frequently occurred if the operator is not experienced. Thus, the conventional manual method has lower production efficiency and a higher cost.

### SUMMARY OF THE INVENTION

A primary objective of the present invention is to provide a computerized method for coloring porcelain tooth that overcomes the disadvantages mentioned above. The computerized method for coloring porcelain tooth according to the present invention sequentially includes a color difference comparison step, a first computer aided process, and a second computer aided process, for precisely controlling the color of the porcelain tooth. The color difference comparison step may accurately calculate the coating proportion and the coating thickness of each position on the surface of the porcelain tooth according to the color data. The first computer aided process forms a first layer on the surface of the porcelain tooth by way of computer aided manufacturing (CAM) according to the coating proportion and the coating thickness calculated by the color difference comparison step. The second computer aided process may form a second layer on the first layer by way of CAM according to the coating proportion and the coating thickness calculated by the color difference comparison step. Moreover, the above steps are accomplished by a computerized coloring device, a drying device, and a high temperature furnace.

The computerized method for coloring the porcelain tooth according to the present invention makes the manufacturing process standardized and computerized by way of CAM. Thus, the operators do not need to be very experienced, and therefore it may reduce labor cost and human error. Besides, the color of the porcelain tooth may be precisely controlled by way of CAM. Thus, the ceramic powder consumption is reduced, and then it further saves cost, improves production efficiency, and shortens delivery time of the porcelain tooth.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a schematic view showing a conventional porcelain tooth structure;

FIG. 2 is a flow chart showing a conventional method for coloring porcelain tooth;

FIG. 3 is a flow chart showing a computerized method for coloring a porcelain tooth according to a first embodiment of the present invention;

FIG. 4 is a flow chart showing the first computer aided process of the computerized method for coloring the porcelain tooth according to the first embodiment of the present invention;

FIG. 5 is a flow chart showing the second computer aided process of the computerized method for coloring the porcelain tooth according to the first embodiment of the present invention;

FIG. 6 is a flow chart showing another computerized method for coloring the porcelain tooth according to a second embodiment of the present invention;

FIG. 7 is a schematic view showing a computerized coloring device according to the present invention;

FIG. 8 is a schematic view showing a porcelain tooth structure according to the first embodiment of the present invention; and

FIG. 9 is a schematic view showing a porcelain tooth structure according to the second embodiment of the present invention.

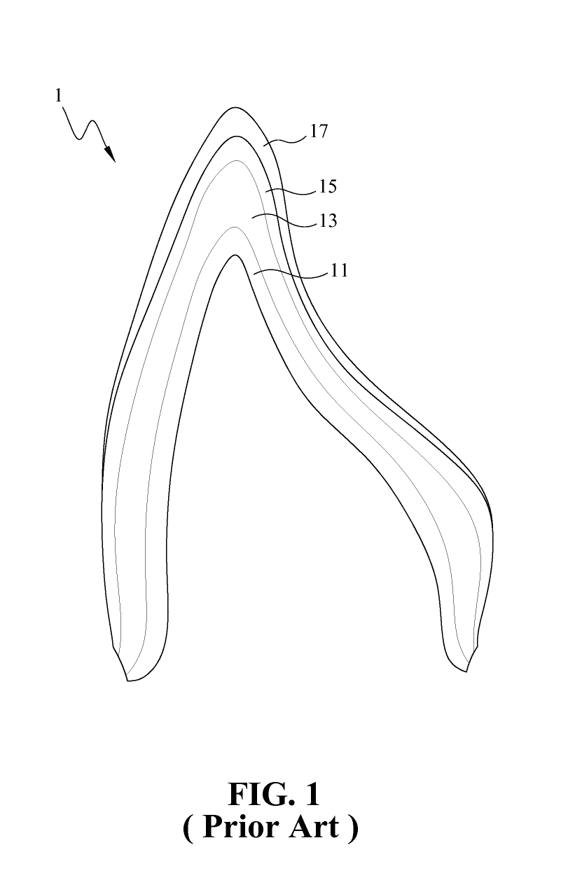

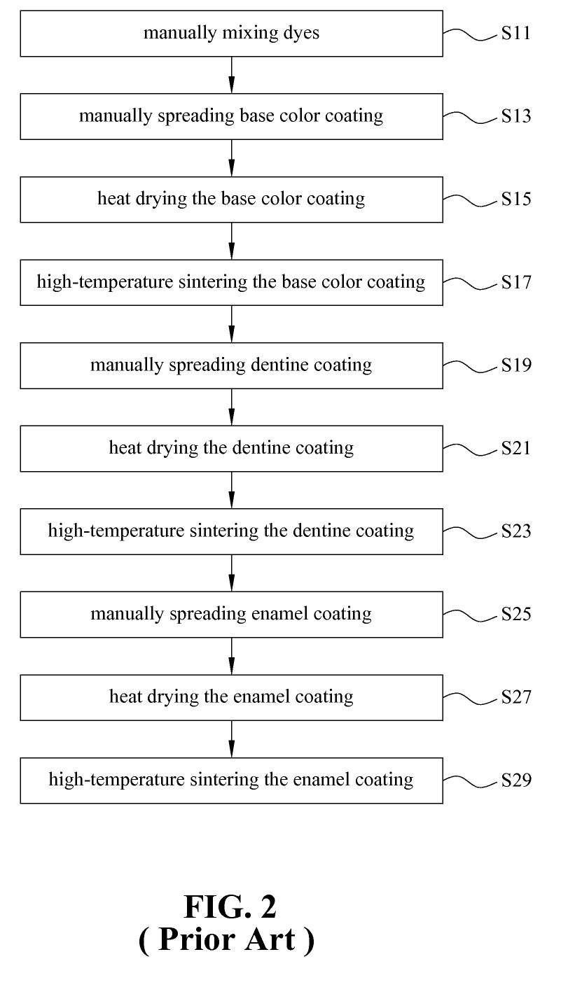

### DETAILED DESCRIPTION OF THE PREFERRED EMBODIMENT

Reference will now be made in detail to embodiments of the present invention, examples of which are illustrated in the accompanying drawings.

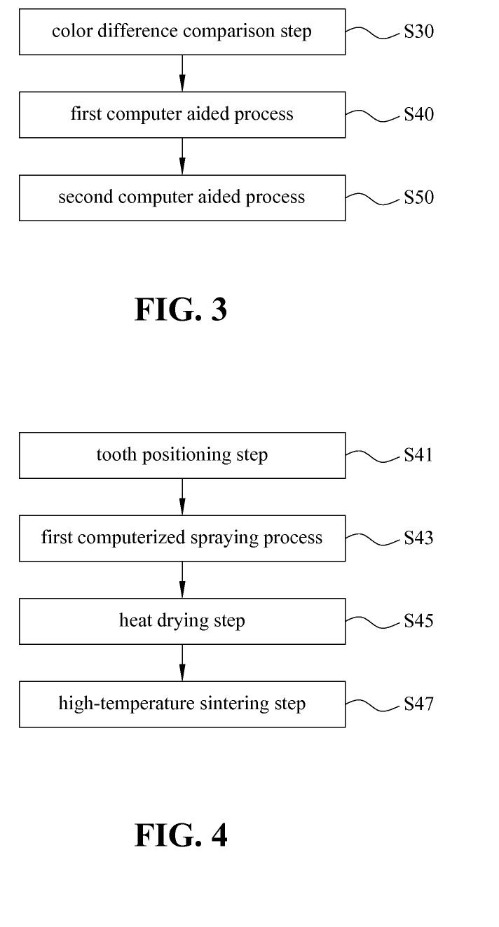

FIG. 3 is a flow chart showing a computerized method for coloring a porcelain tooth according to a first embodiment of the present invention. As shown in FIG. 3, the computerized method for coloring the porcelain tooth according to the present invention sequentially includes the steps of: a color difference comparison step S30, a first computer aided process S40, and a second computer aided process S50, for precisely controlling the color of the porcelain tooth by way of computer aided manufacturing. The color difference comparison step S30 accurately calculates coating proportion and coating thickness on each position of the porcelain tooth according to color data. The first computer aided process S40 forms a first layer on the surface of the porcelain tooth by way of computer aided manufacturing (CAM) according to the coating proportion and the coating thickness calculated by the color difference comparison step S30. The second computer aided process S50 forms a second layer on the first layer by way of CAM according to the coating proportion, the coating thickness, and operating parameters calculated by the color difference comparison step S30.

The color data may be provided by a dentist or a porcelain tooth designer, and then the aforementioned steps are used to precisely control colors by way of CAM, so as to achieve the predetermined color of the porcelain tooth. In addition, the color difference comparison step S30, the first computer aided process S40, and the second computer aided process S50 are accomplished by a computerized coloring device, a drying device, and a high temperature furnace.

FIG. 4 is a flow chart showing the first computer aided process S40 of the computerized method for coloring the porcelain tooth according to the first embodiment of the present invention. As shown in FIG. 4, the first computer aided process S40 includes the steps of: a tooth positioning step S41, a first computerized spraying process S43, a heat drying step S45, and a high-temperature sintering step S47. The tooth positioning step S41 fixes the porcelain tooth in the computerized coloring device, detects a three dimensional contour of the porcelain tooth, and locates spraying positions on the porcelain tooth. The first computerized spraying process S43 sprays a first layer of coating onto the spraying positions on the surface of the porcelain tooth by way of CAM. The coating proportion and the coating thickness are calculated by the color difference comparison step S30 and the spraying position is determined by the tooth positioning step S41. After the first computerized spraying process S43, the heat drying step S45 takes the porcelain tooth sprayed with the first layer of coating out of the computerized coloring device, puts the porcelain tooth into the drying device, and dries the first layer of coating according to a standard drying process. After the heat drying step S45, the high-temperature sintering step S47 takes the porcelain tooth out of the drying device, puts the porcelain tooth into the high temperature furnace and sinters the first layer of coating in high temperature according to a standard sintering process, so as to form the first layer. The first layer of coating may be a base color coating or a mixed coating of a base color coating and a dentine coating.

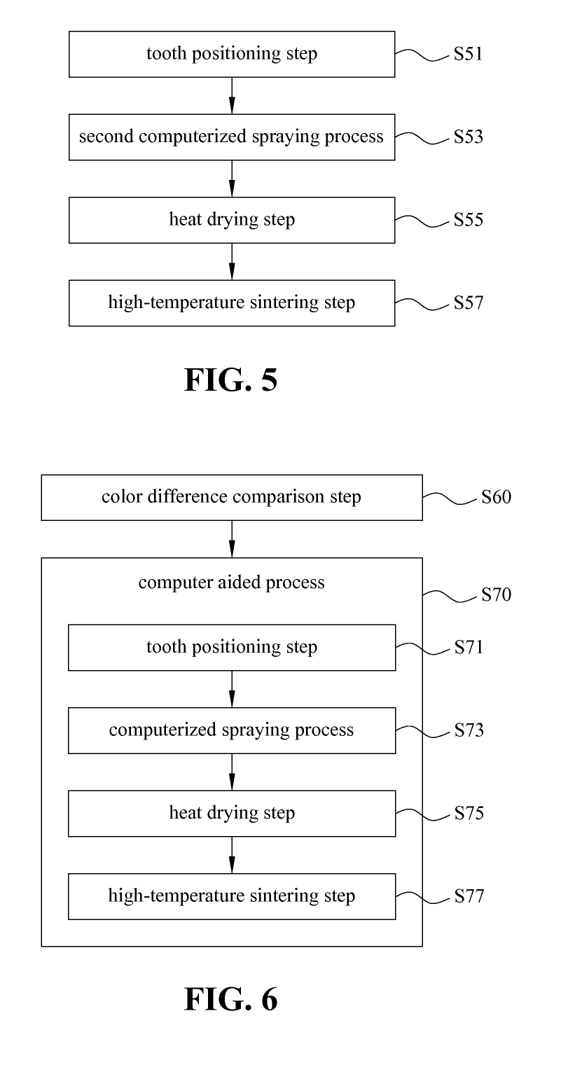

Referring to FIG. 5, a flow chart showing the second computer aided process S50 of the computerized method for coloring the porcelain tooth according to the first embodiment of the present invention is illustrated. As shown in FIG. 5, the second computer aided process S50 includes the steps of: a tooth positioning step S51, a second computerized spraying process S53, a heat drying step S55, and a high-temperature sintering step S57. After the first computer aided process S40, the tooth positioning step S51 fixes the porcelain tooth having the first layer in the computerized coloring device, detects a three dimensional contour of the porcelain tooth, and locates a plurality of spraying positions on the first layer of the porcelain tooth. The second computerized spraying process S53 sprays a second layer of coating on the spraying positions on the surface of the first layer by way of CAM. The coating proportion and the coating thickness are calculated by the color difference comparison step S30 and the spraying position is determined by the tooth positioning step S51. After the second computerized spraying process S53, the heat drying step S55 takes the porcelain tooth having the second layer of coating out of the computerized coloring device, puts it into the drying device and dries the second layer of coating according to the standard drying process. After the heat drying step S55, the high-temperature sintering step S57 takes out the porcelain tooth from the drying device, puts it into the high temperature furnace and sinters the second layer of coating in high temperature according to the standard sintering process, so as to form the second layer. The second layer of coating is a mixed coating of a dentine coating and an enamel coating when the first layer of coating is the base color coating, and the second layer of coating is an enamel coating when the first layer of coating is a mixed coating of the base color coating and the dentine coating.

FIG. 6 is a flow chart showing a computerized method for coloring a porcelain tooth according to a second embodiment of the present invention. As shown in FIG. 6, the computerized method for coloring the porcelain tooth according to the second embodiment of the present invention includes a color difference comparison step S60 and a computer aided process S70. The computer aided process S70 includes a tooth positioning step S71, a computerized spraying process S73, a heat drying step S75, and a high-temperature sintering step S77. The color difference comparison step S60 is the same method as the color difference comparison step S30 of FIG. 3, and the tooth positioning step S71 is the same method as the tooth positioning step S41 of FIG. 4.

The computerized spraying process S73 sprays a dye layer of coating on the spraying positions on the surface of the porcelain tooth by way of CAM. The coating proportion and the coating thickness are calculated by the color difference comparison step S60 and the spraying position is determined by the tooth positioning step S71. After the computerized spraying process S73, the heat drying step S75 takes the porcelain tooth having the dye layer of coating out of the computerized coloring device, puts it into the drying device and dries the dye layer of coating according to the standard drying process. After the heat drying step S75, the high-temperature sintering step S77 takes out the porcelain tooth from the drying device, puts it into the high temperature furnace and sinters the dye layer of coating in high temperature according to the standard sintering process, so as to form the dye layer. The dye layer of coating is a mixed coating of a base color coating, a dentine coating and an enamel coating.

The steps included in FIGS. 4-6, the heat drying steps S45, S55, and S65 have a range of a drying temperature of 30-150 degrees Celsius, and the high-temperature sintering steps S47, S57, and S67 have a range of a sintering temperature of 700-2000 degrees Celsius. The method for coloring the porcelain tooth may be computerized and standardized by using the steps S41-S57 or S71-S77.

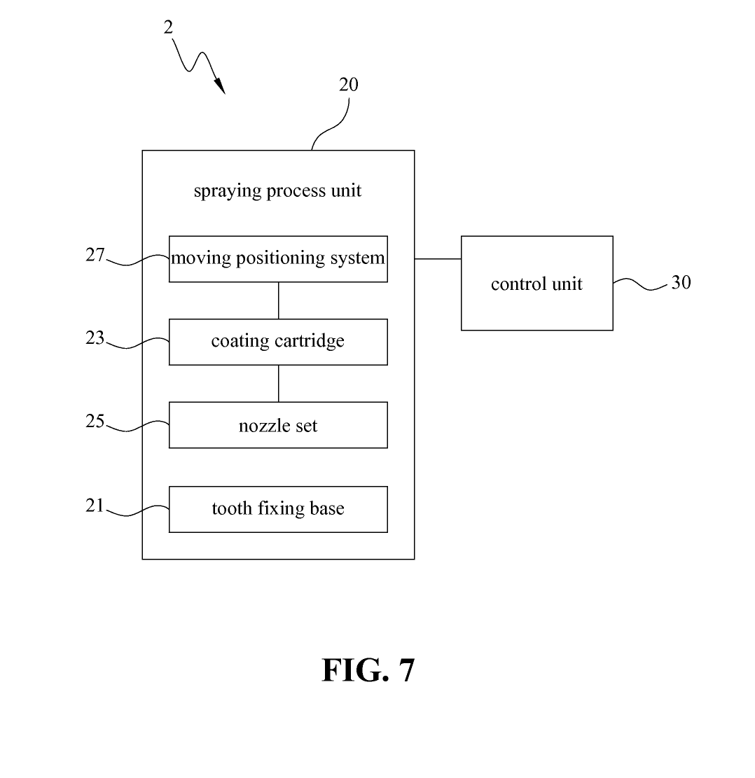

FIG. 7 is a schematic view showing the computerized coloring device 2 according to the present invention. The computerized coloring device 2 according to the present invention includes a spraying process unit 20 and a control unit 30. The spraying process unit 20 includes a tooth fixing base 21, a coating cartridge 23, a nozzle set 25 and a moving positioning system 27. The porcelain tooth is fixed in the tooth fixing base 21. The coating cartridge 23 has plurality sets of coatings (not shown). The nozzle set 25 is connected with the coating cartridge 23. The nozzle set 25 uses at least one of a thermal sublimation manner, a piezoelectricity manner, and a mixing manner to spray the coatings onto the porcelain tooth. The moving positioning system 27 is a robot arm with at least one sensor (not shown), connected with the coating cartridge 25 and electrically connected with the control unit 30. The moving positioning system 27 locates the porcelain tooth in coordination with the control unit 30 for accurately controlling the position and the angle of the nozzle set 25. The coatings are at least one of a metal ion aqueous solution, a metal ion oily solution, and an oxide slurry.

The control unit has a control software for controlling the spraying process unit 20. The control software has a positioning function, a data comparison function, and a performing function. The positioning function executes the three dimensional locating to the porcelain tooth in coordination with the moving positioning system 27, so as to precisely control the nozzle set 25 and the position and the angle of the moving positioning system 27, and therefore accurately colors the porcelain tooth. The data comparison function performs the color difference comparison step S30. The performing function performs the first computer aided process S40, the second computer aided process S50, and the computer aided process S70 based on the positioning function and the data comparison function.

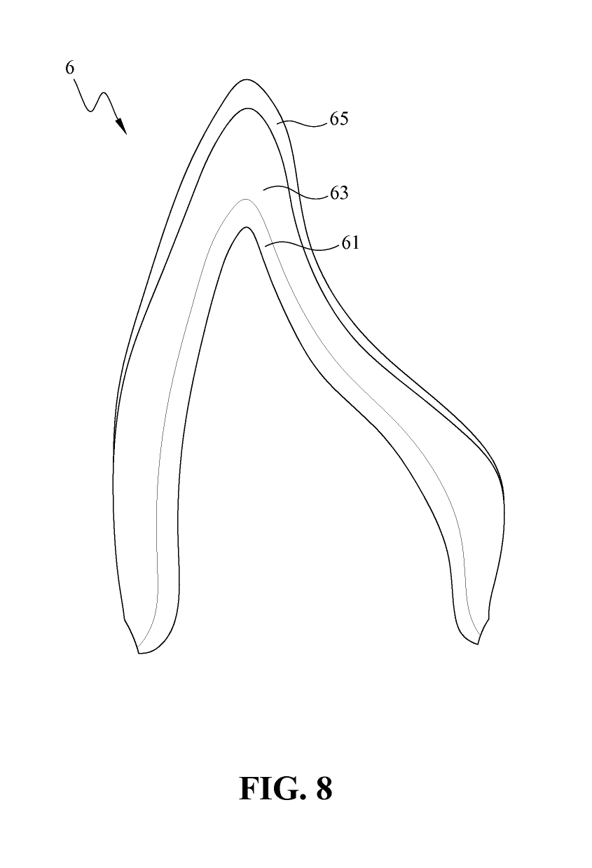

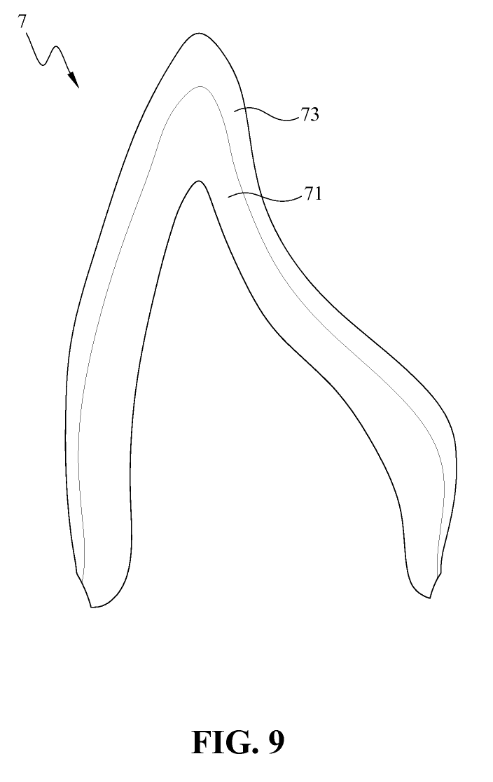

FIGS. 8 and 9 are views showing a porcelain tooth according to the first embodiment and the second embodiment of the present invention, respectively. Referring to FIG. 8, the porcelain tooth structure 6 according to the first embodiment of the present invention includes a porcelain tooth 61, a first layer 63, and a second layer 65, accomplished by the method of FIGS. 3-5. Referring to FIG. 9, the porcelain tooth structure 7 according to the second embodiment of the present invention includes a porcelain tooth 71 and a dye layer 73, accomplished by the method of FIG. 6.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A computerized method for coloring a porcelain tooth, comprising the steps of:
a color difference comparison step for calculating a coating proportion and a coating thickness of the porcelain tooth based on color data;
a first computer aided process for forming a first layer on a surface of the porcelain tooth by way of computer aided manufacturing (CAM) according to the coating proportion and the coating thickness calculated by the color difference comparison step; and
a second computer aided process for forming a second layer on the first layer by way of CAM according to the coating proportion and the coating thickness calculated by the color difference comparison step;
wherein the color difference comparison step, the first computer aided process, and the second computer aided process are used for controlling a color of the porcelain tooth.

2. The method as claimed in claim 1, wherein the first computer aided process comprises the steps of:
a tooth positioning step for fixing the porcelain tooth in a computerized coloring device and locating a plurality of spraying positions on the surface of the porcelain tooth;
a first computerized spraying process for spraying a first layer of coating onto the spraying positions of the porcelain tooth by way of CAM based on the color difference comparison step and the tooth positioning step;
a heat drying step for putting the porcelain tooth into a drying device and drying the first layer of coating; and
a high-temperature sintering step for putting the porcelain tooth into a high temperature furnace and sintering the first layer of coating, so as to form the first layer.

3. The method as claimed in claim 2, wherein the second computer aided process comprises the steps of:
a tooth positioning step for fixing the porcelain tooth with the first layer in the computerized coloring device and locating a plurality of spraying positions on the first layer of the porcelain tooth;
a second computerized spraying process for spraying a second layer of coating onto the spraying positions of the first layer by way of CAM based on the color difference comparison step and the tooth positioning step;
a heat drying step for putting the porcelain tooth into the drying device and drying the second layer of coating; and
a high-temperature sintering step for putting the porcelain tooth into the high temperature furnace and sintering the second layer of coating, so as to form the second layer.

4. The method as claimed in claim 3, wherein the first layer of coating is a base color coating and the second layer of coating is a mixed coating of a dentine coating and an enamel coating.

5. The method as claimed in claim 3, wherein the first layer of coating is a mixed coating of a base color coating and a dentine coating and the second layer of coating is an enamel coating.

6. The method as claimed in claim 2, wherein the computerized coloring device comprises a spraying process unit and a control unit having a control software for performing the color difference comparison step, the first computer aided process and the second computer aided process.

7. The method as claimed in claim 6, wherein the spraying process unit comprises:
a tooth fixing base for fixing the porcelain tooth;
a coating cartridge having plurality sets of coating;
a nozzle set connected with the coating cartridge for spraying the coatings onto the porcelain tooth; and
a moving positioning system having a robot arm with at least one sensor, connecting with the coating cartridge and electrically connecting with the control unit, executing a three dimensional locating to the porcelain tooth in coordination with the control unit for controlling a position and an angle of the nozzle set.

8. The method as claimed in claim 7, wherein the control software has functions of:
a positioning function for executing the three dimensional locating to the porcelain tooth in coordination with the moving positioning system, and for controlling the nozzle set and a position and an angle of the moving positioning system;
a data comparison function for performing the color difference comparison step; and
a performing function for performing the first computer aided process and the second computer aided process based on the positioning function and the data comparison function.

9. The method as claimed in claim 7, wherein the nozzle set uses at least one of a thermal sublimation manner, a piezoelectricity manner, and a mixing manner to spray the coatings onto the porcelain tooth.

10. The method as claimed in claim 7, wherein the coatings are at least one of a metal ion aqueous solution, a metal ion oily solution, and an oxide slurry.

11. The method as claimed in claim 2, wherein the heat drying step has a range of a drying temperature of 30-150 degrees Celsius and the high-temperature sintering step has a range of a sintering temperature of 700-2000 degrees Celsius.

12. A computerized method for coloring a porcelain tooth, comprising the steps of:
a color difference comparison step for calculating a coating proportion and a coating thickness of a porcelain tooth based on color data; and
a computer aided process for forming a dye layer on a surface of the porcelain tooth by way of computer aided manufacturing (CAM) according to the coating proportion and the coating thickness calculated by the color difference comparison step.

13. The method as claimed in claim 12, wherein the computer aided process comprises the steps of:
a tooth positioning step for fixing the porcelain tooth in a computerized coloring device and locating a plurality of spraying positions on the surface of the porcelain tooth;
a computerized spraying process for spraying a dye layer of coating on the spraying positions by way of CAM based on the color difference comparison step and the tooth positioning step;
a heat drying step for putting the porcelain tooth into a drying device and drying the dye layer of coating; and
a high-temperature sintering step for putting the porcelain tooth into a high temperature furnace and sintering the dye layer of coating, so as to form the dye layer.

14. The method as claimed in claim 13, wherein the dye layer of coating is a mixed coating of a base color coating, a dentine coating and an enamel coating.

15. The method as claimed in claim 13, wherein the computerized coloring device comprises a spraying process unit and a control unit having a control software for performing the color difference comparison step and the computer aided process.

16. The method as claimed in claim 15, wherein the spraying process unit comprises:
a tooth fixing base for fixing the porcelain tooth;
a coating cartridge having plurality sets of coating;
a nozzle set connected with the coating cartridge for spraying the coatings onto the porcelain tooth; and
a moving positioning system having a robot arm with at least one sensor, connecting with the coating cartridge and electrically connecting with the control unit, executing a three dimensional locating to the porcelain tooth in coordination with the control unit for controlling a position and an angle of the nozzle set.

17. The method as claimed in claim 16, wherein the control software has functions of:
a positioning function for executing the three dimensional locating to the porcelain tooth in coordination with the moving positioning system, and for controlling the nozzle set and a position and an angle of the moving positioning system;
a data comparison function for performing the color difference comparison step; and
a performing function for performing the computer aided process based on the positioning function and the data comparison function.

18. The method as claimed in claim 16, wherein the nozzle set uses at least one of a thermal sublimation manner, a piezoelectricity manner, and a mixing manner to spray the coatings onto the porcelain tooth.

19. The method as claimed in claim 16, wherein the coatings are at least one of a metal ion aqueous solution, a metal ion oily solution, and an oxide slurry.

20. The method as claimed in claim 20, wherein the heat drying step has a range of a drying temperature of 30-150 degrees Celsius and the high-temperature sintering step has a range of a sintering temperature of 700-2000 degrees Celsius.
